(19) United States
(12) Patent Application Publication
(10) Pub. No.: US 2008/0163261 A1
(43) Pub. Date: Jul. 3, 2008

(54) APPLICATION EXECUTION APPARATUS, STORAGE MEDIUM STORING APPLICATION EXECUTION PROGRAM, AND APPLICATION EXECUTION METHOD

(75) Inventors: Masatoshi Kimura, Kawasaki (JP); Kazuhiro Takeda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/857,530

(22) Filed: Sep. 19, 2007

(30) Foreign Application Priority Data
Dec. 27, 2006 (JP) 2006-350836

(51) Int. Cl. G06F 9/44

(52) U.S. Cl. 719/320

(57) ABSTRACT

An application execution apparatus includes: a notification section capable of providing notification; and an application execution section that causes at least one application capable of performing at least one process to perform a plurality of processes by executing the application, the application issuing, in response to a predetermined result obtained by performing each process, an instruction for causing the notification section to start or stop providing notification. The apparatus further includes: a selection section that selects one of the plurality of processes; and a notification control section that causes the notification section to start or stop providing notification according to an instruction that is issued by the application in response to a result of execution of the process selected by the selection section.

### BACKGROUND OF THE INVENTION

1. Field of the Invention

The present invention relates to an application execution apparatus, a storage medium that stores an application execution program, and an application execution method, which are capable of obtaining a processing result by executing an application.

2. Description of the Related Art

In recent years, since personal computers have become equipped with a built-in antenna for receiving TV radio waves as well as a built-in TV tuner, and besides, distribution of free TV programs dedicated to personal computers via the Internet has been widespread, watching TV programs with a personal computer has become commonplace. Meanwhile, personal computers with a large screen of a size similar to that of an ordinary TV set are now available on the market. Accordingly, the number of users, who use a personal computer as a multifunctional TV set capable of transmitting/receiving e-mails, storing TV programs on a hard disk, and the like, in a living room, is expected to increase.

Meanwhile, personal computers are usually provided with, in addition to an LED for indicating ON/OFF state of the power, other LEDs such as an LED for indicating arrival of e-mails and an LED for indicating loading of various kinds of recording media. In order to use a personal computer as a television, it is necessary to provide the personal computer with additional LEDs such as an LED for indicating that recording is underway and an LED for indicating that a periodical TV program schedule is arriving. Thus, it is difficult for a user to fully remember the correspondence between each LED and the contents to be notified by the LED.

In this respect, Japanese Patent Application Laid-Open No. 2002-79728 describes a technique in which plural types of errors are associated with plural types of emission patterns, and an LED is caused to emit light in an emission pattern according to an error. Also, Japanese Patent Application Laid-Open Nos. 2002-215356 and 2002-67455 each describe a technique in which plural types of errors are associated with various combinations of plural LEDs, and LEDs combined according to an error are caused to emit light. When LED's emission patterns or the like are thus associated with errors and set up beforehand, it is possible to inform a user of an error in a way desired by the user.

However, the number of errors that can be represented by LED's emission patterns or combinations of LEDs is limited. Therefore, the techniques described in Japanese Patent Application Laid-Open Nos. 2002-79728, 2002-215356, and 2002-67455 have such a drawback that a large number of LEDs need to be disposed in a personal computer, which limits variety in design and increases the cost of manufacturing.

Meanwhile, in order to prevent falsification and leakage of data stored in a hard disk, it is desirable to keep updating an antivirus application in a personal computer. For this reason, there is growing demand for promptly informing users that information related to an application such an antivirus application has been updated on a website. In general however, when a user is watching a TV program on a personal computer, icons and the like are not shown on the screen for the purpose of displaying pictures of the TV program as large as possible. Therefore, it is necessary to use a piece of hardware such as an LED, in order to indicate in real time that information is updated. Such indication may be achieved by modifying a conventional personal computer. In this modification however, there is a problem that an additional LED is necessary.

### SUMMARY OF THE INVENTION

In view of the foregoing, the present invention provides an application execution apparatus, a storage medium that stores an application execution program, and an application execution method, which can inform a user of the result of an execution, without limiting the design and increasing the cost.

An application execution apparatus according to the invention includes:

a notification section capable of providing notification;

an application execution section that causes at least one application capable of performing at least one process to perform a plurality of processes by executing the application, the application issuing, in response to a predetermined result obtained by performing each process, an instruction for causing the notification section to start or stop providing notification;

a selection section that selects one of the plurality of processes; and

a notification control section that causes the notification section to start or stop providing notification according to an instruction, which is issued by the application in response to a result of execution of the process selected by the selection section.

According to the application execution apparatus of the invention, one of plural processes is selected, and the notification section notifies a result of performing the selected process if the result is a predetermined result. Therefore, it is possible to notify a user of a result of performing a process required by the user.

In the application execution apparatus according to the invention, preferably, the notification section is a light-emitting device that provides notification by light.

Conventionally, notification of ON/OFF status of the power and loading of a recording medium has been made by light emitted from an LED or the like. When an LED or the like is employed as the notification section of the invention, it is possible to utilize a conventional application execution apparatus by slightly modifying it.

In the application execution apparatus according to the invention, preferably, the application execution section executes a plurality of applications each capable of performing a plurality of processes, and the selection section selects one of the plurality of processes by selecting one of the plurality of applications.

This additional feature makes it possible for a user to reliably confirm the result of executing an application desired by the user.

In the application execution apparatus according to the invention, preferably, the application execution section executes a single application capable of performing a plurality of processes and obtaining results independent of each other by performing the respective processes.

According to this additional feature, update information about each of two or more websites is obtained by means of a single application. Thus, it is possible for a user to select one of the websites as desired, so that the user can be notified of update information about the selected website.

In the application execution apparatus according to the invention, preferably, the application execution section executes a search application capable of accessing an external device and thereby searching for update information for updating a function of the application execution apparatus, the search application issuing the instruction upon finding the update information.

According to this additional feature, information for updating functions of the application execution apparatus is searched for, and a search result is notified when update information is found. Thus, it is possible to keep the functions of the application execution apparatus up to date.

In the application execution apparatus according to the invention, preferably, the application execution section executes a check application capable of accessing an external device and thereby checking whether a predetermined website is updated or not, the check application issuing the instruction upon finding that the predetermined website is updated.

According to the application execution apparatus having this additional feature, it is possible to readily notify a user that his/her desired website is updated, without increasing the number of LEDs or the like.

A storage medium that stores an application execution program according to the invention is a storage medium that stores a program which, when executed in a computer, implements in the computer an application execution apparatus including:

an application execution section that causes at least one application capable of performing at least one process to perform a plurality of processes by executing the application, the application issuing, in response to a predetermined result obtained by performing each process, an instruction for causing a piece of hardware capable of providing notification to start or stop providing notification;

a selection section that selects one of the plurality of processes; and

a notification control section that causes the piece of hardware to start or stop providing notification according to an instruction, which is issued by the application in response to a result of execution of the process selected by the selection section.

According to the application execution program stored in the storage medium of the invention, it is possible to implement an application execution apparatus capable of reliably notifying a user of an execution result, without limiting the design and increasing the cost.

An application execution method according to the invention includes:

an application execution step of causing at least one application capable of performing at least one process to perform a plurality of processes by executing the application, the application issuing, in response to a predetermined result obtained by performing each process, an instruction for causing a piece of hardware capable of providing notification to start or stop providing notification;

a selection step of selecting one of the plurality of processes; and

a notification control step of controlling notification by causing the piece of hardware to start or stop providing notification according to an instruction, which is issued by the application in response to a result of execution of the process selected in the selection step.

According to the application execution method of the invention, it is possible to reliably notify a user of necessary information without increasing the number of LEDs or the like.

As described above, according to the invention, it is possible to notify a user of the result of executing a desired process, without limiting the design and increasing the cost.

### BRIEF DESCRIPTION OF THE DRAWINGS

FIG. 1 is an external perspective view of a personal computer to which an embodiment of the invention is applied;

FIG. 2 is a diagram showing an internal configuration of the personal computer;

FIG. 3 is a diagram showing an example of hardware-software hierarchical relationship configured in the personal computer;

FIG. 4 is a block diagram showing functions of the personal computer;

FIG. 5 is a diagram showing an example of a selection screen for enabling a user to select an item to be notified; and

FIG. 6 is a diagram showing a sequence of processes in which update information is obtained by an update navigation and a user confirms the update information.

### DETAILED DESCRIPTION OF THE INVENTION

Embodiments of the present invention will be described with reference to the attached drawings.

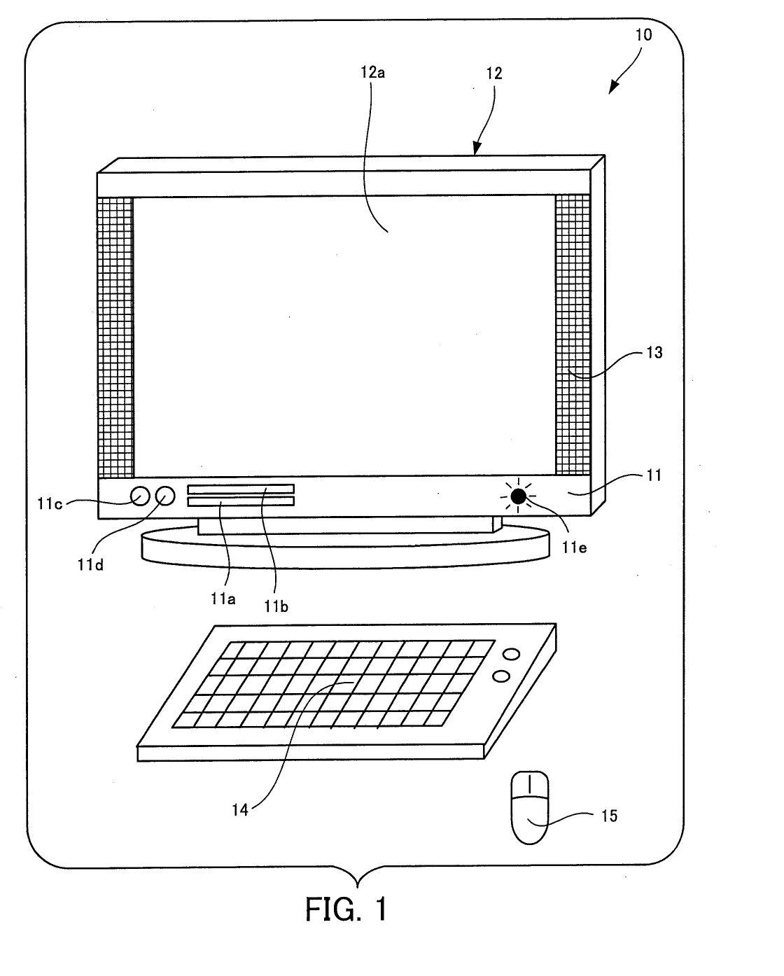

FIG. 1 is an external perspective view of a personal computer 10 to which an embodiment of the invention is applied.

The personal computer 10 has the function of providing ordinary TV programs by receiving television radio waves, and the function of providing Internet-only TV programs by receiving these programs via the Internet. The personal computer 10 is provided beforehand with various kinds of applications such as: a Really Simple Syndication (RSS) reader capable of accessing a predetermined website and thereby obtaining update information available on the website; and an update navigation capable of accessing a website run by the manufacturer of the personal computer 10 and thereby obtaining information for updating various functions provided in the personal computer 10.

When viewed externally, the personal computer 10 is configured such that it has elements such as: a main device 11; an image display device 12 that displays an image on a display screen 12a according to an instruction from the main device 11; a speaker 13 that outputs sounds; a keyboard 14 used for inputting various kinds of information into the main device 11 according to key operations; and a mouse 15 used for designating an arbitrary position on the display screen 12a, thereby inputting an instruction according to, for example, an icon or the like displayed on the designated position. The main device 11 has: an FD loading slot 11a into which a flexible disk (hereinafter referred to as “FD”) is removably inserted; a CD/DVD loading slot lib into which a CD-ROM or a DVD is removably inserted; a TV switch 11c for turning on and off TV functions; a personal-computer switch lid for turning on and off computer functions; and an LED 11e turned on and off according to a result obtained by execution of the RSS reader and the update navigation. The LED 11e is an example of the “notification section” according to the invention. The timing for turning on and off the LED 11e will be described later in detail.

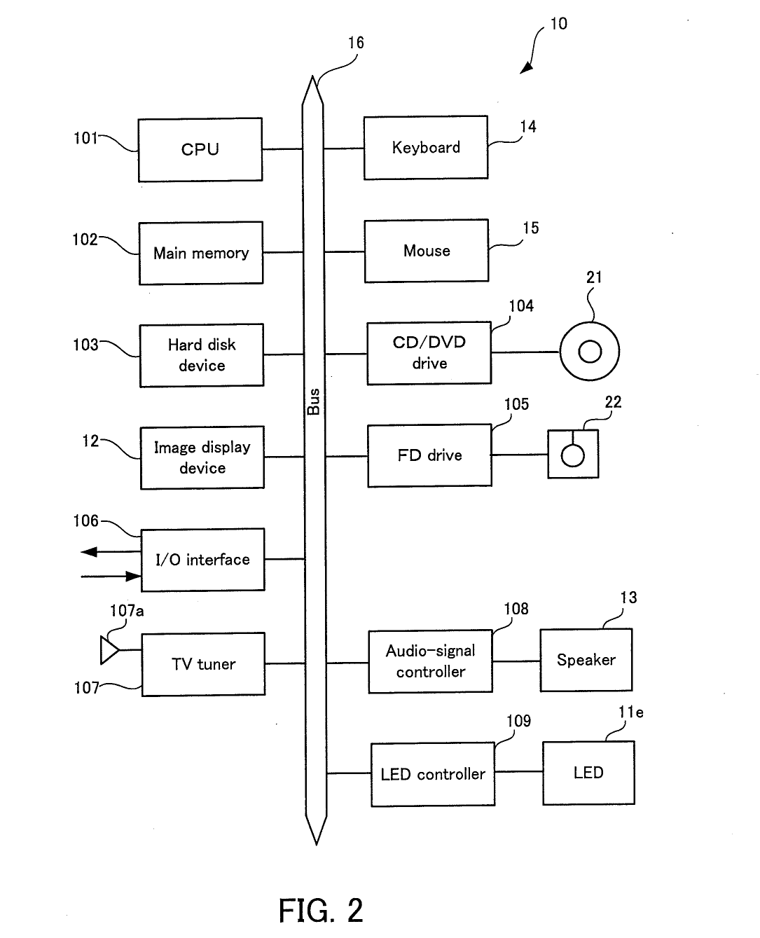

FIG. 2 is a diagram showing an internal configuration of the personal computer 10.

As shown in FIG. 2, the main device 11 internally includes elements such as: a CPU 101 that executes various kinds of programs; a main memory 102 used by the CPU 101 as a work area when the CPU 101 reads out and executes a program stored in a hard disk device 103; the hard disk device 103 that stores various kinds of programs; a CD/DVD drive 104 that accesses a CD-ROM 21 or a DVD removably inserted therein; and an FD drive 105 that accesses a FD 22 removably inserted therein; and an Input/Output (I/O) interface 106 that transmits/receives data to/from an external device. The main device 11 further includes elements such as: an antenna 107a that receives TV programs distributed by radio waves from a television base station; a TV tuner 107 that picks up radio waves of a channel selected by a user from among the radio waves received by the antenna 107a, and converts the selected radio waves into TV program information in digital form; an audio-signal controller 108 that converts audio signals of a TV program into analog signals and transmits the analog signals to the speaker 13; and an LED controller 109 that causes the LED 11e to emit light. The above-described elements as well as the image display device 12, the keyboard 14, and the mouse 15 also shown in FIG. 1 are all interconnected via a bus 16. The keyboard 14 and the mouse 15 are examples of the “selection section” according to the invention, and the CPU 101 is an example of the “application execution section” according to the invention.

The CD-ROM 21 is an embodiment of the “storage medium that stores an application execution program” according to the invention and stores a control program. When the CD-ROM 21 is inserted into the CD/DVD drive 104, the control program stored in the CD-ROM 21 is uploaded to the personal computer 10 and stored in the hard disk device 103. When the control program is launched and executed, the personal computer 10 operates as an embodiment of the “application execution apparatus” according to the invention.

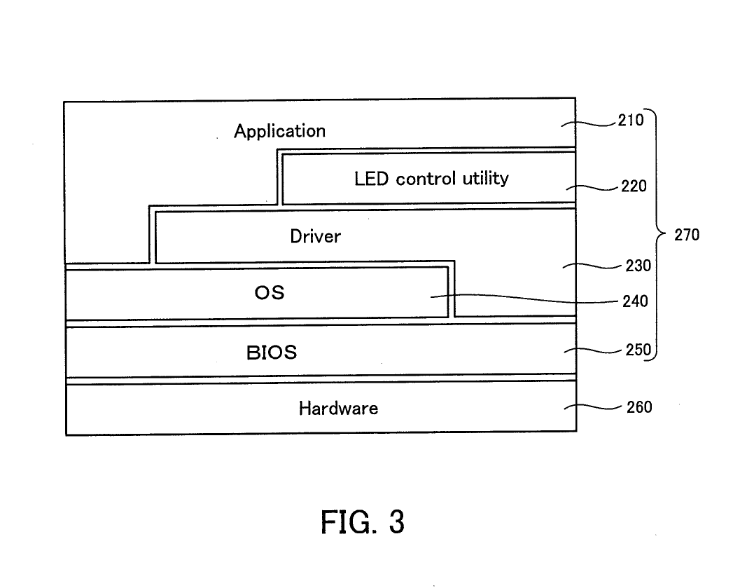

FIG. 3 is a diagram showing an example of hardware-software hierarchical relationship configured in the personal computer 10.

The hierarchical relationship shown in FIG. 3 includes an LED control utility 220 that causes the LED 11e to emit light.

In the personal computer 10, software 270 (including firmware) composed of various kinds of software resides on hardware 260 composed of the elements shown in FIG. 2. Specifically, the software 270 residing on the hardware 260 includes: a basic input output system (BIOS) 250 composed of programs for initializing and controlling the hardware 260; an operating system (OS) 240 for activating the personal computer 10; a driver 230 that provides a control interface for enabling application programs 210 (hereinafter simply referred to as “application 210”) to use the hardware 260; the LED control utility 220 for controlling turning on and off of the LED 11e; and the application 210 composed of application programs such as the RSS reader and the update navigation. In the present embodiment, the OS 240, LED control utility 220 and application 210 shown in FIG. 3 are configured in the CPU 101 shown in FIG. 2, the BIOS 250 and driver 230 shown in FIG. 3 are configured in the LED controller 109 shown in FIG. 2, and the hardware 260 shown in FIG. 3 includes the LED 11e shown in FIG. 2. The LED control utility 220 implements an example of the “notification control section” according to the invention.

The personal computer 10 is basically thus configured.

Subsequently, the timing for turning on and off the LED 11e will be described.

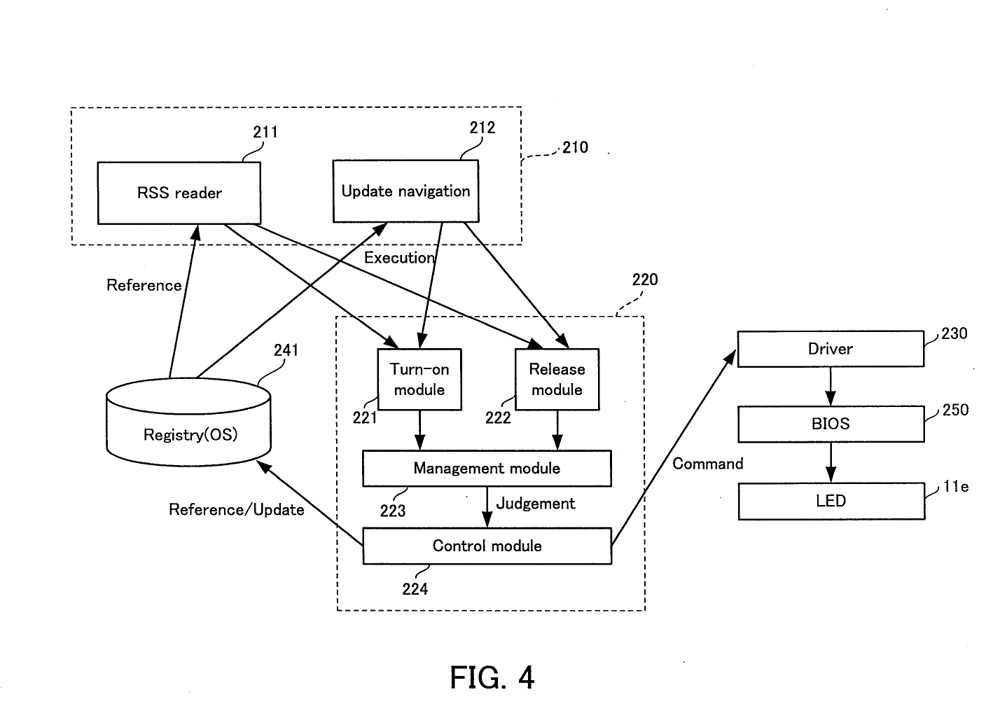

FIG. 4 is a block diagram showing functions of the personal computer 10.

In the OS 240, there is prepared a registry 241 where locations of files for executing a RSS reader 211 and an update navigation 212 and files for executing various modules for turning on and off the LED 11e are defined.

Internet-only TV programs are distributed in the form of moving-image data on a website and thus, a user can watch the TV programs on the personal computer 10 by accessing the website and downloading the moving-image data therefrom. The RSS reader 211 makes the rounds of websites distributing Internet-only TV programs and searches for newly distributed TV programs. In the present embodiment, the RSS reader 211 searches for updated TV programs in five categories of news, sports, movies, music and cartoons. Upon finding an updated TV program in any of these categories, the RSS reader 211 gives an instruction for turning on the LED 11e to the LED control utility 220. Subsequently, upon confirming that the TV program is watched by the user, the RSS reader 211 gives an instruction for turning off the LED 11e to the LED control utility 220.

The update navigation 212 regularly visits the website run by the manufacturer of the personal computer 10 and searches for an update to software such as a driver or an application. Upon finding an update, the update navigation 212 gives an instruction for turning on the LED 11e to the LED control utility 220. Subsequently, upon confirming the user's access to the update, the update navigation 212 gives an instruction for turning off the LED 11e to the LED control utility 220.

The LED control utility 220 includes: a turn-on module 221 that receives a turn-on instruction for turning on the LED 11e; a release module 222 that receives a turn-off instruction for turning off the LED 11e; a management module 223 that selects the turn-on instruction or the turn-off instruction; and a control module 224 that controls turning on and off of the LED 11e according to the instruction selected by the management module 223.

The control module 224 gives an instruction for turning on/off the LED 11e to the driver 230. The driver 230 sends the received instruction to the BIOS 250, thereby turning on/off the LED 11e.

In the present embodiment, a user can select an application or the like as an item to be notified by the LED 11e. Thus, there will be described a sequence of processes in which a user selects an item to be notified by the LED 11e and then, the LED 11e is turned on and off for the selected item.

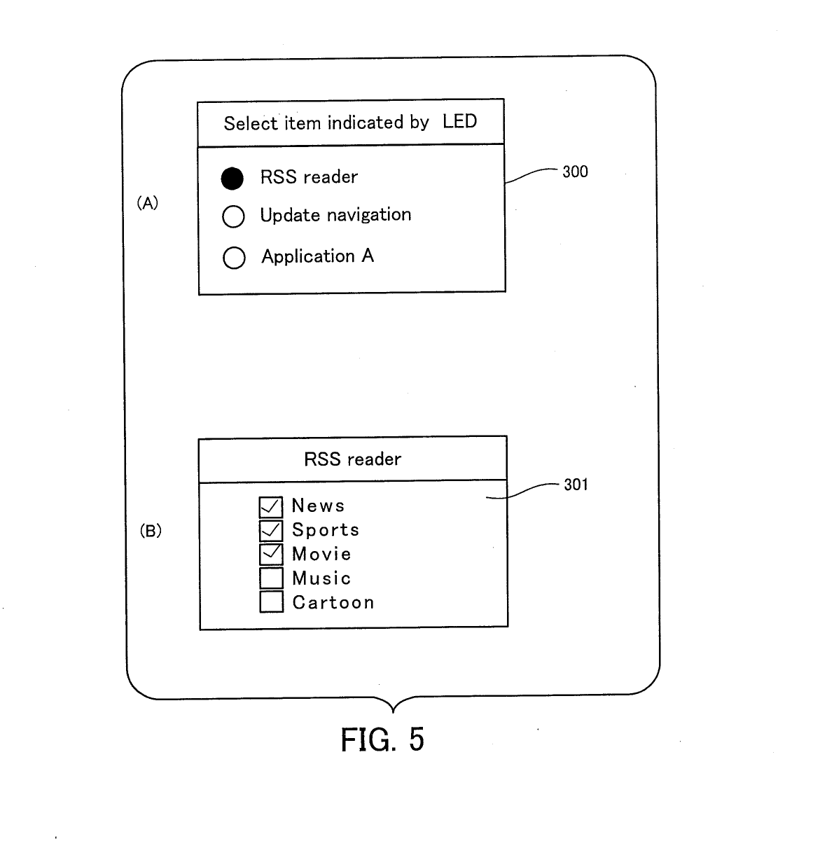

FIG. 5 is a diagram showing an example of selection screen for enabling a user to select an item to be notified.

In the personal computer 10, an icon for displaying a selection screen 300 is prepared beforehand. In response to selection of the icon by the user with the mouse 15, the selection screen 300 shown in Part (A) of FIG. 5 appears on the display screen 12a.

The selection screen 300 provides radio buttons that enable a user to select one of applications including the RSS reader 211 and the update navigation 212. For example, in response to selection of the radio button representing the “RSS reader” by the user, a selection sub-screen 301 for selecting TV programs shown in Part (B) of FIG. 5 appears.

The selection sub-screen 301 shown in Part (B) of FIG. 5 provides check boxes that enable the user to make a selection from the above-mentioned categories: news, sports, movies, music and cartoons, as many as desired. The RSS reader 211 then searches for a new TV program in each of the categories selected in the selection sub-screen 301, and the LED 11e is turned on when a new TV program is found. In this way, a desired website or the like can be selected by the user beforehand so that the user is promptly notified of the fact that the selected website is updated, which makes it possible for the user to efficiently and reliably obtain necessary information.

Here, for example, suppose the user selects the radio button representing the “update navigation” on the screen shown in Part (A) of FIG. 5 with the mouse 15. Then, in response to the selection, the fact that the “update navigation” is selected is notified to the management module 223 shown in FIG. 4. The above-described process for selecting an application such as the update navigation or selecting a category on a website is an example of the “selection step” in the application execution method according to the invention.

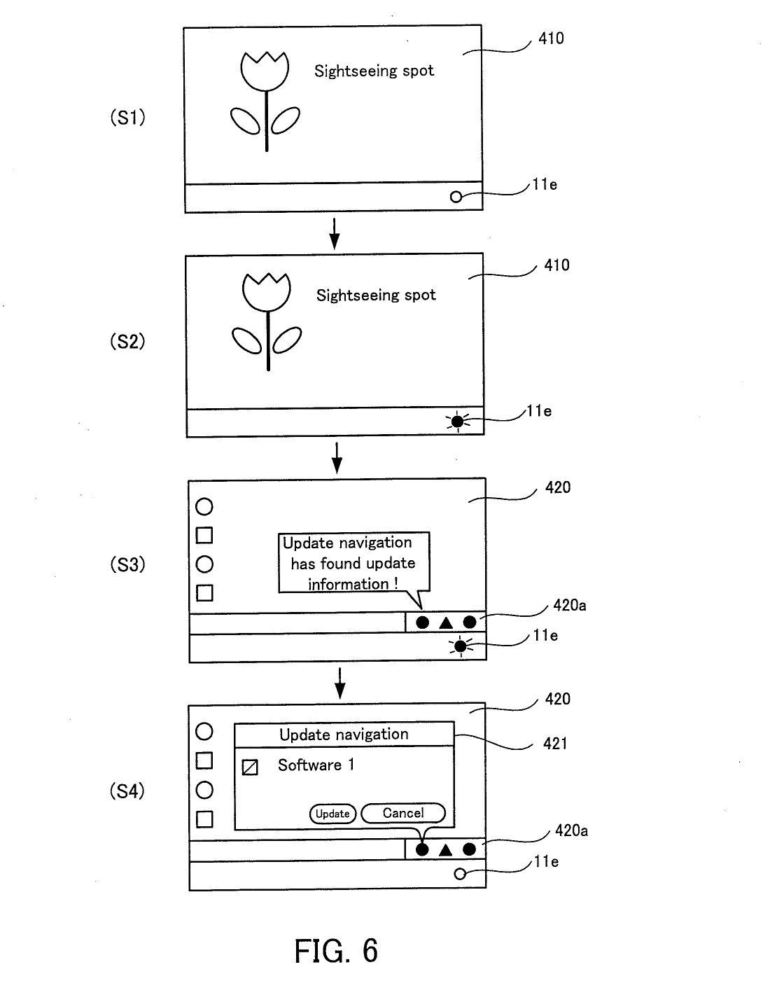

FIG. 6 is a diagram showing a sequence of processes in which update information is obtained by the update navigation and a user confirms the update information.

While the personal computer 10 is being used as an ordinary television, a TV program 410 fully occupies the display screen 12a and thus, icons and the like are not displayed on the display screen 12a (step S1 in FIG. 6).

The RSS reader 211 and the update navigation 212 shown in FIG. 4 regularly visit predetermined websites, and give turn-on instructions to the turn-on module 221 upon finding a new TV program and update information, respectively. The turn-on instruction given to the turn-on module 221 is sent to the management module 223. The process for executing the RSS reader 211 and the update navigation 212 is an example of the “application execution step” in the application execution method according to the invention.

The management module 223 judges a received turn-on instruction “allowable” if it is sent from the update navigation 212 selected by the user, but it judges a received turn-on instruction “unallowable” if it is sent from the RSS reader 211 that is not selected by the user. A judgment result and a turn-on instruction are sent to the control module 224.

The control module 224 accepts only a turn-on instruction judged allowable by the management module 223 and sends the accepted turn-on instruction to the driver 230. In this example, only the turn-on instruction sent from the update navigation 212 is accepted and sent to the driver 230, while the turn-on instruction sent from the RSS reader 211 is not accepted. In this way, turning on/off of the LED 11e is controlled by transmitting an instruction from an application to the BIOS 250 according to a selection made by the user, and this process is an example of the “notification control step” in the application execution method according to the invention.

The turn-on instruction received by the driver 230 is then sent to the BIOS 250, so that the LED 11e is turned on (step S2 in FIG. 6).

Since the LED 11e is thus turned on, a user can recognize that the information about the personal computer 10 is updated, while watching a TV program. Subsequently, upon switching from the TV function to the computer function by the user with, for example, the mouse 15, a personal computer (PC) screen 420 appears on the display screen 12a (step S3 in FIG. 6). On the PC screen 420, icons 420 for notifying results obtained by execution of the respective applications such as the update navigation 212 and the RSS reader 211 are displayed.

Upon selection of the icon 420a representing the update navigation 212 by the user with the mouse 15, the personal computer 10 accesses the website, thereby displaying an update screen 421 for downloading update information from the website (step S4 in FIG. 6).

Upon display of the update screen 421, the update navigation 212 issues a turn-off instruction to the release module 222 shown in FIG. 4. The turn-off instruction is then sent to the management module 223 where it judges the received turn-off instruction issued by the update navigation 212 allowable. Subsequently, the turn-off instruction thus judged allowable is sent to and accepted by the control module 224. The turn-off instruction accepted by the control module 224 is sent to the BIOS 250 via the driver 230, so that the LED 11e is turned off.

Incidentally, for example, if a turn-off instruction from the RSS reader 211 arrives at the management module 223, before arrival of a turn-off instruction from the update navigation 212, the management module 223 judges the turn-off instruction from the update navigation 212 unallowable. Thus, it is possible to prevent such an inconvenience that the LED 11e is turned off before update information is confirmed by the user.

In this way, according to the present embodiment, it is possible to inform a user of only the result obtained by performing a process desired by the user, without increasing the number of LEDs, thereby achieving reduction in cost and improvement in design. Besides, the user can promptly obtain the latest information since it is possible to indicate the presence of update information and the like while displaying a TV program in a full screen mode.

In the above description, a personal computer to which the application execution apparatus of the invention is applied has been taken as an example. However, the application execution apparatus of the invention may be applied to other types of devices such as a portable telephone.

What is claimed is:

1. An application execution apparatus comprising:
a notification section capable of providing notification;
an application execution section that causes at least one application capable of performing at least one process to perform a plurality of processes by executing the application, the application issuing, in response to a predetermined result obtained by performing each process, an instruction for causing the notification section to start or stop providing notification;
a selection section that selects one of the plurality of processes; and
a notification control section that causes the notification section to start or stop providing notification according to an instruction, which is issued by the application in response to a result of execution of the process selected by the selection section.

2. The application execution apparatus according to claim 1, wherein the notification section is a light-emitting device that provides notification by light.

3. The application execution apparatus according to claim 1, wherein the application execution section executes a plurality of applications each capable of performing a plurality of processes, and
the selection section selects one of the plurality of processes by selecting one of the plurality of applications.

4. The application execution apparatus according to claim 1, wherein the application execution section executes a single application capable of performing a plurality of processes and obtaining results independent of each other by performing the respective processes.

5. The application execution apparatus according to claim 1, wherein the application execution section executes a search application capable of accessing an external device and thereby searching for update information for updating a function of the application execution apparatus, the search application issuing the instruction upon finding the update information.

6. The application execution apparatus according to claim 1, wherein the application execution section executes a check application capable of accessing an external device and thereby checking whether a predetermined website is updated or not, the check application issuing the instruction upon finding that the predetermined website is updated.

7. A storage medium that stores an application execution program which, when executed in a computer, implements in the computer an application execution apparatus comprising:
an application execution section that causes at least one application capable of performing at least one process to perform a plurality of processes by executing the application, the application issuing, in response to a predetermined result obtained by performing each process, an instruction for causing a piece of hardware capable of providing notification to start or stop providing notification;
a selection section that selects one of the plurality of processes; and
a notification control section that causes the piece of hardware to start or stop providing notification according to an instruction, which is issued by the application in response to a result of execution of the process selected by the selection section.

8. The storage medium according to claim 7, wherein the piece of hardware is a light-emitting device that provides notification by light.

9. The storage medium according to claim 7, wherein the application execution section executes a plurality of applications each capable of performing a plurality of processes, and
the selection section selects one of the plurality of processes by selecting one of the plurality of applications.

10. The storage medium according to claim 7, wherein the application execution section executes a single application capable of performing a plurality of processes and obtaining results independent of each other by performing the respective processes.

11. The storage medium according to claim 7, wherein the application execution section executes a search application capable of accessing an external device and thereby searching for update information for updating a function of the application execution apparatus, the search application issuing the instruction upon finding the update information.

12. The storage medium according to claim 7, wherein the application execution section executes a check application capable of accessing an external device and thereby checking whether a predetermined website is updated or not, the check application issuing the instruction upon finding that the predetermined website is updated.

13. An application execution method comprising:
an application execution step of causing at least one application capable of performing at least one process to perform a plurality of processes by executing the application, the application issuing, in response to a predetermined result obtained by performing each process, an instruction for causing a piece of hardware capable of providing notification to start or stop providing notification;
a selection step of selecting one of the plurality of processes; and
a notification control step of controlling notification by causing the piece of hardware to start or stop providing notification according to an instruction, which is issued by the application in response to a result of execution of the process selected in the selection step.

14. The application execution method according to claim 13, wherein the piece of hardware is a light-emitting device that provides notification by light.

15. The application execution method according to claim 13, wherein the application execution step is a step of executing a plurality of applications each capable of performing a plurality of processes, and
the selection step is a step of selecting one of the plurality of processes by selecting one of the plurality of applications.

16. The application execution method according to claim 13, wherein the application execution step is a step of executing a single application capable of performing a plurality of processes and obtaining results independent of each other by performing the respective processes.

17. The application execution method according to claim 13, wherein the application execution step is a step of executing a search application capable of accessing an external device and thereby searching for update information for updating a function of an application execution apparatus, the search application issuing the instruction upon finding the update information.

18. The application execution method according to claim 13, wherein the application execution step is a step of executing a check application capable of accessing an external device and thereby checking whether a predetermined website is updated or not, the check application issuing the instruction upon finding that the predetermined website is updated.
